(19) United States
(12) Patent Application Publication
(10) Pub. No.: US 2007/0255568 A1
(43) Pub. Date: Nov. 1, 2007

(54) Methods for communicating a menu structure to a user within a vehicle

(75) Inventor: Scott M. Pennock, Lake Orion, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/414,119

(22) Filed: Apr. 28, 2006

(51) Int. Cl. G10L 21/00

(52) U.S. Cl. 704/270

(57) ABSTRACT

A method for communicating a menu structure to a user within a vehicle includes assigning menu levels to predetermined sets of spatial coordinates of a vehicle interior, each menu level spatially corresponding to at least one of the sets of spatial coordinates. An audio prompt is played through one or more vehicle audio components to create a perception that the prompt is originating from the set(s) of spatial coordinates. The audio prompt relates to the menu level corresponding to the set(s) of spatial coordinates.

### TECHNICAL FIELD

The present invention relates generally to menu structures, and more particularly to methods for communicating a menu structure to a user within a vehicle.

### BACKGROUND

Some in-vehicle navigation systems give drivers/passengers the option of using them, at least in a limited (if not full) manner when the vehicle is in operation. Further, speech-enabled telephonic systems in vehicles give drivers the option of using the phone when the vehicle is in operation, while maintaining two hands on the steering wheel. Such systems often have a main menu with a variety of sub-menus. Such a system may be difficult, in some instances, for a user to navigate. The relative complexity of the menu structure, in addition to the variety of distractions that may arise while driving, may cause a user to become “lost” within the vehicle menu structure.

As such, it would be desirable to provide a system that is capable of improving the presentation of a menu structure to a user for more efficient navigation through such menu structure.

### SUMMARY

A method for communicating a menu structure to a user within a vehicle includes assigning menu levels to predetermined sets of spatial coordinates of a vehicle interior, each menu level spatially corresponding to at least one of the sets of spatial coordinates. An audio prompt is played through one or more vehicle audio components to create a perception that the prompt is originating from the set(s) of spatial coordinates. The audio prompt relates to the menu level corresponding to the set(s) of spatial coordinates.

### BRIEF DESCRIPTION OF THE DRAWINGS

Objects, features and advantages of embodiments of the present disclosure may become apparent by reference to the following detailed description and drawings, in which:

FIG. 1 is a schematic diagram depicting an embodiment of a system which may utilize an embodiment of the method of communicating the menu structure;

FIG. 2 is a flow diagram depicting an embodiment of a method for communicating a menu structure to a vehicle;

FIG. 3 is a schematic view of a vehicle audio system suitable for communicating a menu structure to a vehicle;

FIG. 4 is a cutaway perspective view of a user in a vehicle having an audio prompt playing through a predetermined component of the vehicle audio system that spatially corresponds to a main menu;

FIG. 5 is a cutaway perspective view of the user in the vehicle of FIG. 4, where another audio prompt is playing through a different predetermined component of the vehicle audio system that spatially corresponds to an intermediate level menu; and

FIG. 6 is a cutaway perspective view of the user in the vehicle of FIGS. 4 and 5, where yet another audio prompt is playing through a different predetermined component of the vehicle audio system that spatially corresponds to a low level menu.

### DETAILED DESCRIPTION OF THE EMBODIMENTS

Embodiment(s) of the system and method(s) disclosed herein advantageously allow a menu structure to be delivered to and/or perceived to be delivered to a vehicle user from spatially separated components of the vehicle audio system. The vehicle audio system component(s) and/or predetermined sets of spatial coordinates (defined further herein) of the vehicle interior are pre-assigned to correspond with a particular menu level. Audio prompts from a particular menu level may be played from the component(s) that is/are assigned to represent that menu level. It is believed that such a system may assist users in efficiently and effectively navigating the speech-enabled menu structure by providing additional information about in which level of the menu structure the user is then-currently located. Embodiments of the method may advantageously provide improved presentation of a menu structure, which may substantially prevent users from “getting lost” within the menu structure.

It is to be understood that, as defined herein, a user may include vehicle operators and/or passengers.

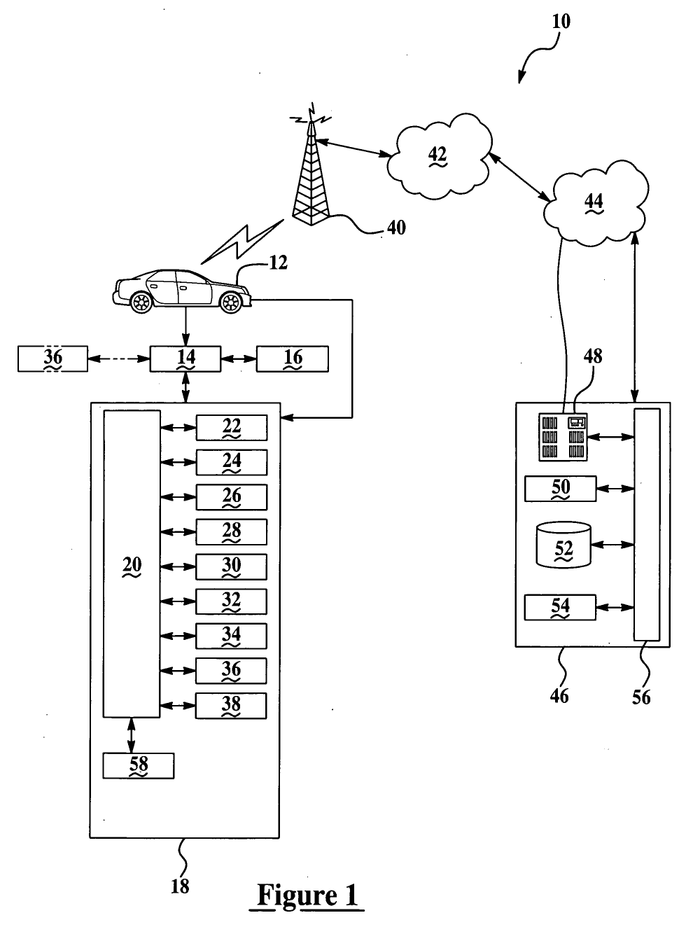

Referring now to FIG. 1, the system 10 includes a vehicle 12, a vehicle communications network 14, a telematics unit 18, a two-way radio frequency communication system (including, but not limited to, one or more wireless carrier systems 40, one or more communication networks 42, and/or one or more land networks 44), and one or more call centers/service providers 46. In one embodiment, vehicle 12 is a mobile vehicle with suitable hardware and software for transmitting and receiving voice and data communications. System 10 may include additional components suitable for use in telematics unit 18.

In an embodiment, via vehicle communications network 14, the vehicle 12 may send signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone or TTY compatible mobile phone 32, a vehicle compatible TTY unit 36, and/or a short-range wireless communication network 38 (e.g. a Bluetooth® unit).

It is to be understood that the telematics unit 18 may be implemented without one or more of the above listed components, such as, for example, speakers 30. Yet further, it is to be understood that the speaker 30 may be a component of the vehicle audio system, which may accept audio and/or other prompts/signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS provides accurate time and latitude and longitude coordinates of the vehicle 12 responsive to a GPS broadcast signal received from a GPS satellite constellation (not shown).

In-vehicle mobile phone 32 may be a cellular type phone, such as, for example an analog, digital, dual-mode, dual-band, multi-mode and/or multi-band cellular phone.

Associated with processor 20 may be a real time clock (RTC) 34 providing accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g. call signals) between telematics unit 18, wireless carrier system 40, and call center 46. The processor 20 may have, but is not limited to having, monitoring, computational, decision-making, and communication capabilities.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46 (also referred to herein as a service provider). In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones and/or mobile phones. It is to be understood that the communications network 42 and the land network 44 connect the wireless carrier system 40 to the call center 46.

Call center/service provider 46 may contain one or more data switches 48, one or more communication services managers 50, one or more communication services databases 52 containing subscriber profile records and/or subscriber information, one or more communication services advisors 54, and/or one or more network systems 56.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. Switch 48 receives data transmissions from, or sends data transmissions to one or more of the communication service manager(s) 50, the communication services database(s) 52, and/or the communication services advisor(s) 54 via the network system(s) 56.

Call center 46 may contain one or more service advisors 54. In one embodiment, service advisor 54 may be human. In another embodiment, service advisor 54 may be an automaton.

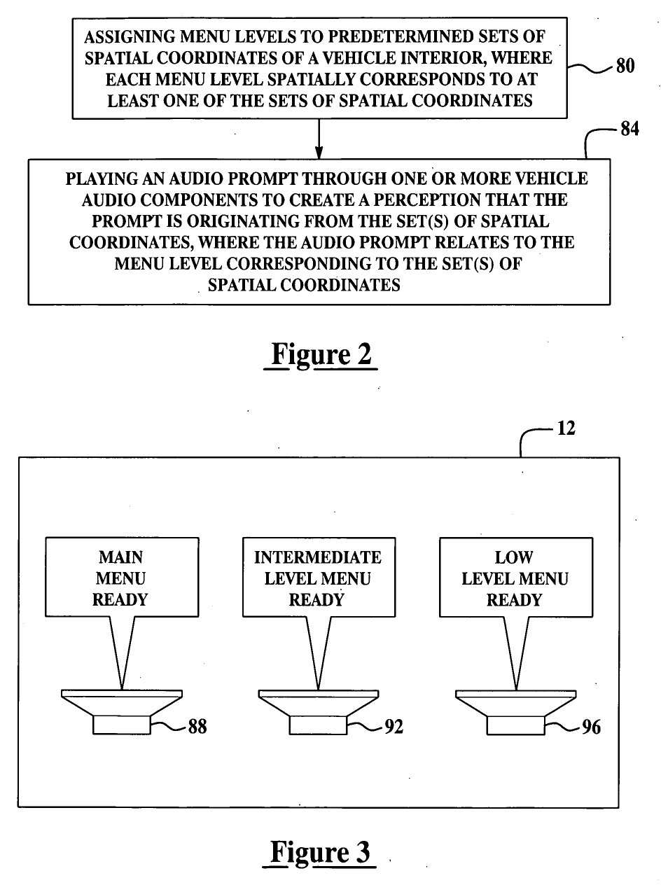

Referring now to FIG. 2, an embodiment of a method for communicating a menu structure to a vehicle 12 includes assigning menu levels to predetermined sets of spatial coordinates of a vehicle 12 interior, where each menu level spatially corresponds to at least one of the sets of spatial coordinates, as shown at reference numeral 80. The method further includes playing an audio prompt through one or more vehicle audio components to create a perception that the prompt is originating from the set(s) of spatial coordinates, where the audio prompt relates to the menu level corresponding to the set(s) of spatial coordinates, as shown at reference numeral 84. For example, it may be advantageous to play a “beep tone” corresponding to the set(s) of spatial coordinates when prompting a user for input. A “beep tone” is a short, non-verbal prompt that alerts the user for an utterance.

It is to be understood that, as used herein, sets of spatial coordinates may be any predefined set of vehicle 12 interior spatial locations. For example, one set may simply be the location corresponding to a single speaker placement in the vehicle 12; another set may be spatial locations oriented as positions on an imaginary horizontal circle surrounding the driver and fixed relative to the driver's facing forward position. For example, positions on the circle may include 12 o'clock, 3 o'clock, 6 o'clock and 9 o'clock, where 12 o'clock is the driver facing forward position. Another set of spatial coordinates may be the right speakers and the left speakers, etc. In addition, it is to be understood that variations in vertical positions of the spatial locations may be utilized and not bound to a physical location of a speaker if the vehicle 12 sound system includes speaker placement allowing vertical source perception.

In a non-limitative example embodiment wherein the sets of spatial coordinates correspond to components of the vehicle 12 audio system, the method includes assigning menu levels to predetermined components of a vehicle audio system, and playing an audio prompt through at least one of the predetermined components, wherein the audio prompt relates to the assigned menu level of the predetermined component(s). It is to be understood that each menu level may spatially correspond to one of the predetermined components. A predetermined component is, for example, a speaker or set of speakers.

In another embodiment, the method may include directing a user of the vehicle 12 to a predetermined menu level by playing an audio prompt through one or more vehicle 12 audio components to create a perception that the prompt is originating from the set(s) of spatial coordinates, the audio prompt relating to the menu level corresponding to the set(s) of spatial coordinates.

In a non-limitative example embodiment wherein the sets of spatial coordinates correspond to components of the vehicle 12 audio system, the method may include directing a user of the vehicle 12 to a predetermined menu level by playing an audio prompt from the predetermined component that spatially corresponds to the predetermined menu level. It is to be understood that, in embodiment(s) disclosed herein, menu level(s) are not necessarily tied/constrained to the physical location of a predetermined component (e.g. a speaker).

The predetermined sets of spatial coordinates/predetermined components of the vehicle audio system are assigned different levels of the menu structure. The assignments may be made, for example, as the vehicle 12 is manufactured. As such, the user may be informed, prior to using the vehicle 12 for the first time, as to which set of spatial coordinates/component corresponds with which menu level. In an embodiment, at least two different predetermined sets of spatial coordinates are each assigned a different menu level. In a non-limitative example embodiment wherein the sets of spatial coordinates correspond to components of the vehicle 12 audio system, at least two different predetermined components of the vehicle audio system are each assigned a different menu level.

The menu levels may be selected from several menus, for example, a main menu, an intermediate menu, and a low level menu. It is to be understood that any desirable number of menus levels may be used, and that numerous intermediate and low level menus (e.g., intermediate level one, intermediate level two, etc.) may be assigned to those levels. In an embodiment, the main menu is assigned to a first predetermined set of spatial coordinates or a first predetermined component (non-limitative examples of which include left speakers, rear left speakers, front left speakers, left door speakers, front left door speakers, rear left door speakers, and combinations thereof), the intermediate level to a second predetermined set of spatial coordinates or a second predetermined component different from the first predetermined set or first predetermined component (non-limitative examples of which include center speakers, front center speakers, rear center speakers, headliner speakers, and combinations thereof), and the low level to a third predetermined set of spatial coordinates or a third predetermined component different from each of the first and second predetermined sets or first and second predetermined components (non-limitative examples of which include right speakers, front right speakers, rear right speakers, right door speakers, front right door speakers, rear right door speakers, and combinations thereof).

The levels of the menu structure are assigned so that one level spatially corresponds with one set of spatial coordinates/component(s) of the vehicle audio system and so that another level spatially corresponds with another set of spatial coordinates/component(s) of the vehicle audio system. The two sets/components are spatially separated from one another. It is to be understood that “spatial correspondence” allows a user to perceive a sound (i.e., an audio prompt) coming from various or different points in 3-dimensional space, rather than from just one location. Spatial correspondence may utilize both binaural (e.g., interaural time differences, interaural level differences, etc.) and monaural cues (e.g., level, ratio of direct-to-reflected signal, etc.) to influence perceived location of the emitted audio prompts. In essence, the information about a user's then-current position in the menu structure may be conveyed by associating locations in the menu structure (i.e., main menu, intermediate or low level menu) with predetermined locations/components in the vehicle 12.

In another example, the menus may emulate differing branches of a tree-like menu structure. The user may perceive a menu branching to the right at a particular node if the tree-like menu structure graphically branches to the right.

In an embodiment, a service provider 46 may generate the audio prompt, and may then transmit the audio prompt to the predetermined set/component of the vehicle audio system via the two-way communication system. Prior to transmitting the audio prompt, however, the method may further include initiating, from a user of the vehicle 12, communication with the service provider 46.

As a non-limitative example, a vehicle operator/user may encounter a vehicle menu structure when initiating a communication, such as a phone call, via an input system. It is to be understood, however, that the vehicle menu structure may be associated with any suitable vehicle 12 system and/or function. The input system is in communication with the two-way radio frequency communication system. Initiation of the communication may be verbal and/or via a physical motion. As such, the input system may include an alphanumeric keypad, a microphone 28, a menu selection system, and/or combinations thereof.

Verbal communication may take place via microphone 28 coupled to the in-vehicle or mobile phone 32 associated with the telematics unit 18. Caller utterances into the microphone 28 are received at a call center 46, which tokenizes the utterance stream for further processing. In one embodiment, the tokenized utterances are placed in a subscriber information database 52 at the call center 46.

Physically initiating communication may be accomplished via a button press, touch screen, or the like located in the vehicle 12. It is to be understood that the button press or touch screen may be operatively connected to the telematics unit 18. Upon the user's initiation of the button press or touch screen, the telematics unit 18 may notify the call center 46 of the fact that the user has initiated a communication.

A user may inform the call center 46 (either verbally or by using a TTY unit 36) of his/her desire to initiate communication. The TTY unit 36 may be useful in the present embodiment(s) if, for example, the person initiating the communication is hearing-impaired, but the user/operator of the vehicle 12 is not hearing-impaired.

After the audio prompt(s) is/are generated at the call center 46, they are transmitted to, and played through predetermined components of the vehicle audio system. As previously indicated, the particular audio prompt that is played corresponds with the menu level that is assigned to the vehicle audio system component(s) from which it is played. As such, the audio prompt communicates the menu levels and/or contents thereof to the vehicle 12 user. Without being bound to any theory, it is believed that the connection between a particular menu level, its corresponding spatially separated set of spatial coordinates/vehicle audio system component(s), and the audio prompt(s) played therefrom may substantially reduce cognitive load and reaction times of users who may rely more on spatial orientation rather than on the content of a prompt or message.

The vehicle audio system components through which the audio prompts are played may include, but are not limited to, front speakers, rear speakers, right speakers, left speakers, center speakers, front right speakers, front left speakers, front center speakers, rear right speakers, rear left speakers, rear center speakers, door speakers, rear door speakers, front door speakers, right door speakers, left door speakers, front right door speakers, front left door speakers, rear right door speakers, rear left door speakers, headliner speakers, and/or combinations thereof.

Embodiments of the method may also include playing more than one audio prompt sequentially. In an example embodiment, a first audio prompt is played from a first component, thereby directing the user to the menu that spatially corresponds with the first component, and then a second audio prompt is played from a second (different) component, thereby directing the user to the menu that spatially corresponds with the second (different) component.

Referring now to FIG. 3, an embodiment of a schematic vehicle audio system having three front vehicle speakers, a left front speaker 88, a center front speaker 92, and a right front speaker 96, is shown. In the embodiment depicted, the left front speaker 88 has been assigned to correspond (or to be perceived as corresponding) with a main menu, the center front speaker 92 has been assigned to correspond (or to be perceived as corresponding) with an intermediate menu, and the right front speaker 96 has been assigned to correspond (or to be perceived as corresponding) with a low level menu. Each spatially separated speaker 88, 92, 96 represents (is perceived to represent) a different menu level to a user when an audio prompt is emitted from that particular speaker. As such, a user is able to identify in which menu level he/she is currently, based upon which speaker 88, 92, 96 plays/is perceived to play the audio prompt (or which direction (i.e., left, right, center) the user perceives as the source of the audio prompt). Thus, a user does not have to rely on memory to maintain his/her location within the menu structure, and may instead identify his/her location by spatial reference.

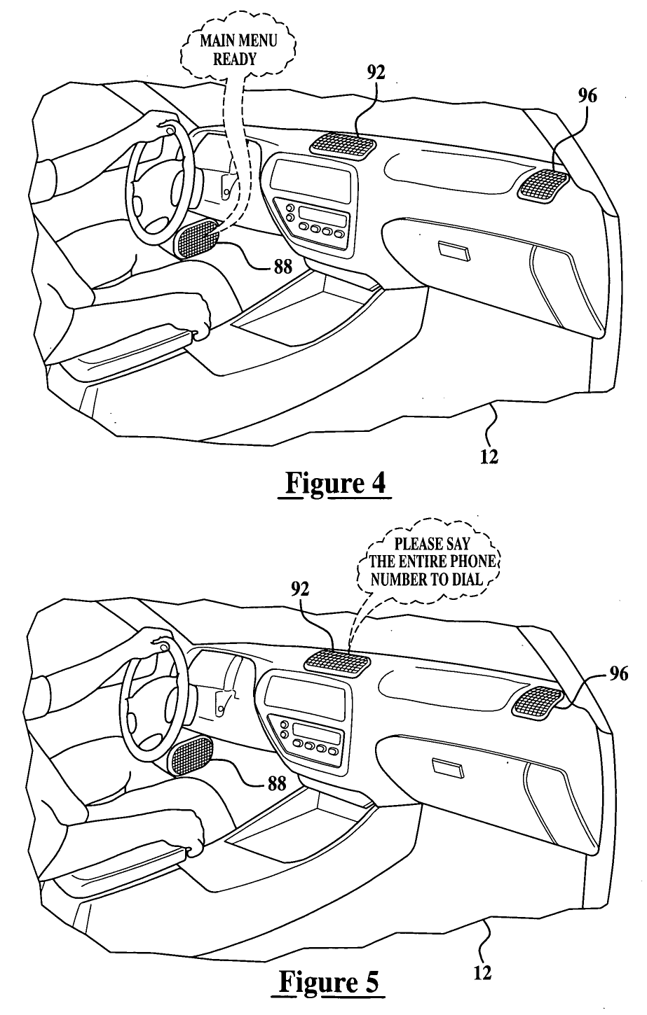

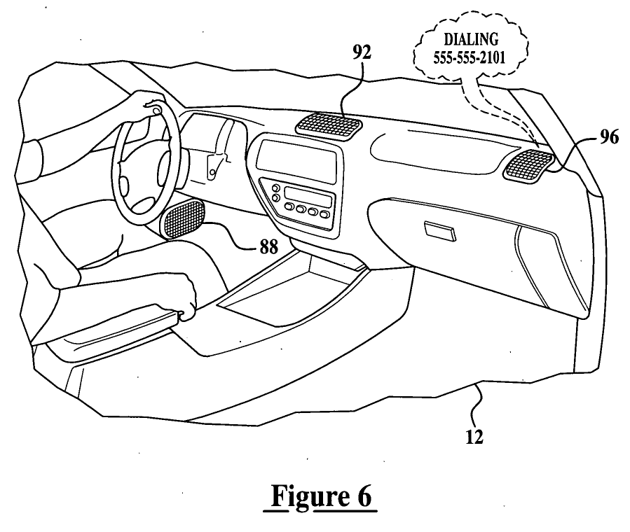

FIGS. 4-6 illustrate a user in a vehicle 12 that is playing (perceived to be playing), respectively, the different embodiments of the audio prompts of FIG. 3. More specifically, FIG. 4 shows a main menu prompt playing through the left front speaker 88, FIG. 5 shows an intermediate level prompt playing through the center front speaker 92, and FIG. 6 shows a low level prompt playing through the right front speaker 96. As the user is previously aware of the assigned menu levels, the spatially separated components and corresponding prompts allow the user to more efficiently navigate the menu structure.

In any of the embodiments disclosed herein, as the audio prompt is played, the method may further include controlling gain, delay, filtering, and/or selection of a predetermined component(s); and/or controlling the vehicle's audio balance and/or fade. For example, in the embodiment of FIG. 4, a main menu prompt may be perceived as playing through the left front speaker 88, while in reality, the prompt is playing through all speakers with balance, fade and volume being individually controlled for each speaker to render the perception of sound emanating from only the left front speaker 88.

While several embodiments have been described in detail, it will be apparent to those skilled in the art that the disclosed embodiments may be modified. Therefore, the foregoing description is to be considered exemplary rather than limiting.

1. A method for communicating a menu structure to a user within a vehicle, comprising:
assigning menu levels to predetermined sets of spatial coordinates of a vehicle interior, each menu level spatially corresponding to at least one of the sets of spatial coordinates; and
playing an audio prompt through one or more vehicle audio components to create a perception that the prompt is originating from the at least one of the sets of spatial coordinates, the audio prompt relating to the menu level corresponding to the at least one of the sets of spatial coordinates.

2. The method as defined in claim 1 wherein the one or more vehicle audio components are selected from front speakers, rear speakers, right speakers, left speakers, center speakers, front right speakers, front left speakers, front center speakers, rear right speakers, rear left speakers, rear center speakers, door speakers, rear door speakers, front door speakers, right door speakers, left door speakers, front right door speakers, front left door speakers, rear right door speakers, rear left door speakers, headliner speakers, and combinations thereof.

3. The method as defined in claim 1 wherein the menu level is selected from a main menu, an intermediate level menu, and a low level menu.

4. The method as defined in claim 3 wherein the main menu is assigned to a first predetermined set of spatial coordinates, the intermediate level menu is assigned to a second predetermined set of spatial coordinates different from the first predetermined set of spatial coordinates, and the low level menu is assigned to a third predetermined set of spatial coordinates different from each of the first and second predetermined sets of spatial coordinates.

5. The method as defined in claim 4 wherein the first predetermined set of spatial coordinates corresponds to vehicle audio components selected from left speakers, rear left speakers, front left speakers, left door speakers, front left door speakers, rear left door speakers, and combinations thereof; wherein the second predetermined set of spatial coordinates corresponds to vehicle audio components selected from center speakers, front center speakers, rear center speakers, and combinations thereof; and wherein the third predetermined set of spatial coordinates corresponds to vehicle audio components selected from right speakers, front right speakers, rear right speakers, right door speakers, front right door speakers, rear right door speakers, headliner speakers, and combinations thereof.

6. The method as defined in claim 1 wherein to create the perception that the prompt is originating from the at least one of the sets of spatial coordinates, as the audio prompt is played, the method further comprises at least one of: controlling at least one of gain, delay, filtering, or selection of the one or more vehicle audio components; or controlling at least one of the vehicle's audio balance or fade.

7. The method as defined in claim 1 wherein a service provider causes the audio prompt to be transmitted through the one or more vehicle audio components.

8. The method as defined in claim 7 wherein, prior to playing the audio prompt, the method further comprises initiating, from the user within the vehicle, communication with the service provider.

9. The method as defined in claim 1, further comprising playing an other audio prompt through one or more vehicle audio components to create a perception that the prompt is originating from at least an other of the sets of spatial coordinates, the audio prompt relating to the menu level corresponding to the at least an other of the sets of spatial coordinates.

10. A method for communicating a menu structure to a user within a vehicle, comprising:
means for assigning menu levels to predetermined components of a vehicle audio system, each menu level spatially corresponding to one of the predetermined components; and
means for providing an audio prompt to at least one of the predetermined components, the audio prompt relating to the assigned menu level.

11. A method for communicating a menu structure to a user within a vehicle, comprising:
assigning menu levels to predetermined sets of spatial coordinates of a vehicle interior, each menu level spatially corresponding to at least one of the sets of spatial coordinates; and
directing the user to a predetermined menu level by playing an audio prompt through one or more vehicle audio components to create a perception that the prompt is originating from the at least one of the sets of spatial coordinates, the audio prompt relating to the menu level corresponding to the at least one of the sets of spatial coordinates.

12. The method as defined in claim 11 wherein the one or more vehicle audio components are selected from front speakers, rear speakers, right speakers, left speakers, center speakers, front right speakers, front left speakers, front center speakers, rear right speakers, rear left speakers, rear center speakers, door speakers, rear door speakers, front door speakers, right door speakers, left door speakers, front right door speakers, front left door speakers, rear right door speakers, rear left door speakers, headliner speakers, and combinations thereof.

13. The method as defined in claim 11 wherein the menu level is selected from a main menu, an intermediate level menu, and a low level menu.

14. The method as defined in claim 13 wherein the main menu is assigned to a first predetermined set of spatial coordinates, the intermediate level menu is assigned to a second predetermined set of spatial coordinates different from the first predetermined set of spatial coordinates, and the low level menu is assigned to a third predetermined set of spatial coordinates different from each of the first and second predetermined sets of spatial coordinates.

15. The method as defined in claim 14 wherein the first predetermined set of spatial coordinates corresponds to vehicle audio components selected from left speakers, rear left speakers, front left speakers, left door speakers, front left door speakers, rear left door speakers, and combinations thereof; wherein the second predetermined set of spatial coordinates corresponds to vehicle audio components selected from center speakers, front center speakers, rear center speakers, and combinations thereof; and wherein the third predetermined set of spatial coordinates corresponds to vehicle audio components selected from right speakers, front right speakers, rear right speakers, right door speakers, front right door speakers, rear right door speakers, headliner speakers, and combinations thereof.

16. The method as defined in claim 11 wherein to create the perception that the prompt is originating from the at least one of the sets of spatial coordinates, as the audio prompt is played, the method further comprises at least one of: controlling at least one of gain, delay, filtering, or selection of the one or more vehicle audio components; or controlling at least one of the vehicle's audio balance or fade.

17. The method as defined in claim 11 wherein a service provider causes the audio prompt to be transmitted through the one or more vehicle audio components.

18. The method as defined in claim 17 wherein, prior to directing the user, the method further comprises initiating, from the user, communication with the service provider.

19. The method as defined in claim 11, further comprising directing the user of the vehicle to an other menu level by playing an other audio prompt through one or more vehicle audio components to create a perception that the prompt is originating from at least an other of the sets of spatial coordinates, the audio prompt relating to the menu level corresponding to the at least an other of the sets of spatial coordinates.

20. A system for communicating a menu structure to a user within a vehicle, comprising:
at least two different components of a vehicle audio system; and
a different menu level assigned to each of the at least two different components.
